(19) United States
(12) Patent Application Publication
(10) Pub. No.: US 2005/0129916 A1
(43) Pub. Date: Jun. 16, 2005

(54) Decorative chairmat

(76) Inventor: Sharon Grace-Moore, Pontiac, MI (US)

Correspondence Address: ARTZ & ARTZ, P.C., 28333 TELEGRAPH RD., SUITE 250, SOUTHFIELD, MI, 48034, US

(21) Appl. No.: 11/043,655

(22) Filed: Jan. 26, 2005

Related U.S. Application Data
(63) Continuation-in-part of application No. 10/208,085, filed on Jul. 29, 2002.
(60) Provisional application No. 60/309,089, filed on Jul. 31, 2001.

(51) Int. Cl. B32B 3/00

(52) U.S. Cl. 428/204

(57) ABSTRACT

A chairmat and a method for making the same is provided that has a substrate layer, a decorative material disposed on the substrate layer, and a seal layer disposed on the decorative material opposite the substrate layer. The method includes applying decorative material to the substrate and applying a seal layer to the decorative material so that the decorative material is between the sealing layer and the substrate.

### RELATED APPLICATIONS

The present invention claims priority to U.S. Provisional Application No. 60/309,089, filed Jul. 31, 2001, entitled “Decorative Chairmat” and is a continuation-in-part of U.S. patent application Ser. No. 10/208,085, now abandoned, both of which are hereby incorporated by reference.

### TECHNICAL FIELD

The present invention relates generally to chairmats, and more particularly, to a method and apparatus for making decorative chairmats.

### BACKGROUND

Chairmats are generally a mundane part of office decor. Typically, chairmats are formed from a plastic material that is clear or a solid color. Chairmats are used to provide a rolling surface on which office chairs more easily move. This helps reduce wear on the carpeting.

Typical chairmats are unappealing due to the thick plastics used, whether they are colored or uncolored. This is particularly noticeable in a home office environment or in a professional office environment outside the home.

It would therefore be desirable to provide an aesthetically pleasing chairmat to add a variety of interest and decoration to an office environment while protecting the floor from the wear and tear from a chair.

### SUMMARY OF THE INVENTION

The present invention provides an improved chairmat that is aesthetically pleasing by allowing various designs to be incorporated therein.

In one aspect of the invention, a chairmat for a floor includes a planar substrate layer having a front side adjacent to the floor and a second side opposite the floor. The chairmat further includes a decorative material that is directly disposed on the second side of the substrate layer. A transparent seal layer is disposed on the decorative layer material opposite the substrate layer.

In yet another aspect of the invention, the decorative material may be placed on top of the substrate layer or beneath the substrate layer.

In yet another aspect of the invention, a method for making a chairmat comprises applying a decorative material to a substrate; and applying a sealing layer to the decorative material so that the decorative material is between the sealing layer and the substrate. If the decorative material is included in the seal layer, the layers are formed simultaneously.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a top plan view of a chairmat according to the present invention.

FIG. 2 is a partial cross-sectional view of a first embodiment of the present invention.

FIG. 3 is a partial cross-sectional view of an edge of the chairmat of FIG. 2.

FIG. 4 is a partial cross-sectional view of a second embodiment of the present invention.

### DESCRIPTION OF THE PREFERRED EMBODIMENT

In the following description the same reference numerals will be used to identify the same components in the various views. Although specific materials and designs are provided in this description, these are not meant to be limiting.

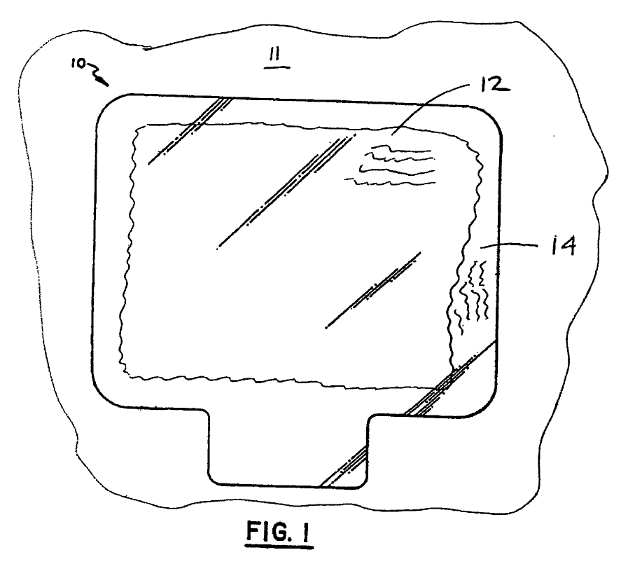

Referring now to FIG. 1, a top view of a chairmat 10 formed according to the present invention is illustrated disposed on a floor 11. The chairmat 10 has a generally planar structure. Chairmat 10 has a design portion 12 in the middle thereof. A second design portion 14 such as a border is also illustrated. First design portion 12 may extend completely to the edges of chairmat 10 on some or part of the sides. Second design portion 14 may be eliminated.

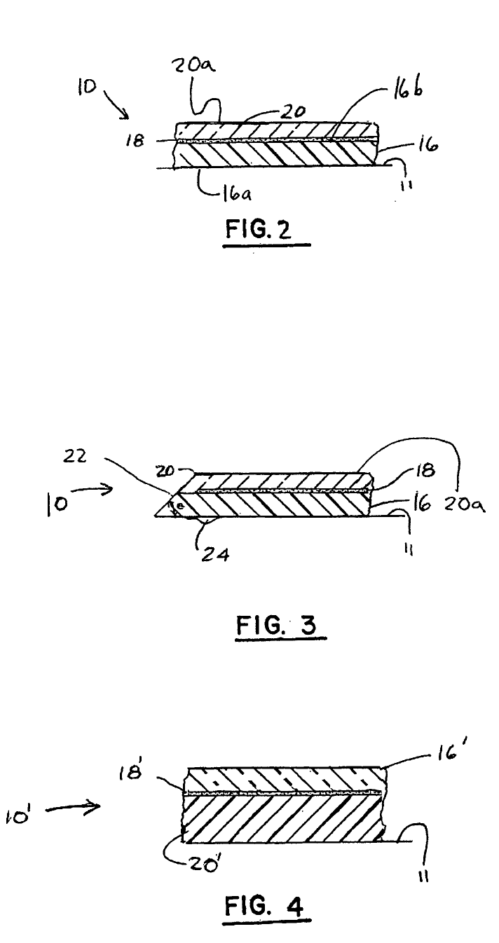

Referring now to FIG. 2, one embodiment of a chairmat 10 formed according to the present invention is illustrated. In this embodiment a continuous planar substrate 16 is provided. Substrate 16 is disposed upon the floor 11. That is, the substrate has a first side 16a adjacent to the floor 11 and a second side 16b disposed opposite or away from the floor 11. Because of the planar nature the sides 16a and 16b are parallel. Substrate 16 may be formed of various types of non-conductive, non-electrical plastic-type materials such as polyvinylchloride or polypropylene. The substrate 16 is rigid.

A decorative material 18 is disposed directly on the second side 16b of the substrate 16. thereon. Decorative material 18 may be various types of decorative materials such as, but not limited to, paint, pencil, plastic, ink, paper, charcoal, polyurethane, crayon, glue, in-laid objects, and combinations thereof. The decorative material 18 forms a decorative layer that is generally disposed in a plane. The decorative material 18 may be discontinuous or continuous, may extend to the edge or leave a border therebetween, or may be formed of different types of materials for different portions such as an edge or border portion being formed of a different decorative material than a central portion.

A protective coating or sealing layer 20 is disposed directly upon the decorative material 18. The sealing layer 20 is also generally planar. Of course, if the decorative material 18 is discontinuous, a portion of the sealing layer 20 may also contact the substrate layer 16. For example, if no decorative material is placed around a border portion, the sealing layer 20 and substrate layer 16 may contact there. Also, in parts of the first design portion 12 shown in FIG. 1, portions of the sealing layer 20 without decorative material 18 may also contact the second side 16b of the substrate layer 16. The sealing layer 20 may be formed of various types of materials. Preferably, a durable polymeric material is employed. For example, the application of several coats of polyurethane material may be employed. Such a material becomes rigid when cured. The sealing layer may be relatively thinner than the substrate. The sealing layer 20 may also be a non-electrical plastic non-conductive material. Other types of material such as a laminated type material may also be used. The sealing layer 20 has an upper surface 20a that is preferably smooth to highlight the design therebeneath. However, textured surfaces may also be employed. When smooth, surface 20a is parallel to the floor 11 and thus parallel to the sides 16a, 16b of the substrate.

By directly applying the decorative material to the substrate layer 16 and the seal layer 20 to the decorative layer, adhesives are avoided. The seal layer 20 is a conforming layer in the sense that it conforms to the shape of the decorative material on its lowermost side.

It should be noted that the decorative material can be pigment in a polymer layer that is applied to the substrate. That is, the seal layer 20 and the decorative material may be integral. One example of such an integral material may be pigmented polyurethane.

Referring now to FIG. 3, an edge 22 of a chairmat is illustrated. In this embodiment, substrate 16 is shown contacting the sealing layer 20. That is, decorative material 18 does not extend entirely to the edge. The edge also has an angle θ to facilitate the rolling of wheels thereover. In addition, nubs 24 may be positioned along the bottom of substrate 18. Nubs 24 help keep the chairmat in place. Nubs 24 may be made out a material that digs into the carpeting to maintain the chairmat 10 secure thereto. If chairmat 10 is to be employed on a tile surface a non-skid type nub 24 such as a rubberized nub may be employed.

Referring now to FIG. 4, a second embodiment of a chairmat 10′ is illustrated. In this embodiment, substrate 16′ has decorative material 18′ disposed on a bottom or lower surface thereof. The sealing layer 20′ is disposed on the decorative material 18′. In this embodiment, substrate 16′ is preferably transparent so that the decorative material 18 shows therebeneath. Substrate 16 may also be partially transparent so that only portions of the decorative material 18′ show therethrough. This may be useful for creating a design pattern using both the substrate 16′ and the decorative material 18′.

In operation, the chairmat may be assembled by shaping the chairmat into a desired shape. This may be performed using cutting tools. Preformed substrates may also be used. Decorative materials are added to the substrate. The decorative material may use various mediums described above. The application of the various mediums depends on the type of medium.

A seal layer is applied to the decorative material to protect the decorative material and maintain contact with the decorative material on the substrate 16. One suitable application is the use of a polyurethane material over the design material. Of course, other types of materials may be used for the sealing layer. Therefore, the application and curing of such sealing layer depends upon the material of the sealing layer.

It should be noted that the application of the decorative material 18 to the substrate 16 depends on which embodiment is desired. For example, the decorative material 18 is used on the bottom surface of substrate 16 for that of FIG. 4, while the decorative material 18 is placed upon the upper surface of substrate 16 for the embodiment illustrated in FIGS. 2 and 3.

While particular embodiments of the invention have been shown and described, numerous variations and alternate embodiments will occur to those skilled in the art. Accordingly, it is intended that the invention be limited only in terms of the appended claims.

1. A chairmat for a floor comprising:
a planar substrate layer having a first side adjacent to the floor and a second side opposite the floor;
decorative material disposed directly on said second side of said substrate layer; and
a transparent seal layer disposed directly on said decorative material opposite said substrate layer.

2. A chairmat as recited in claim 1 wherein said seal layer is at least partially disposed on said substrate.

3. A chairmat as recited in claim 1 wherein said decorative material is disposed on a portion of said substrate.

4. A chairmat as recited in claim 1 wherein said decorative material is disposed on a portion of said substrate to form a substrate border without decorative material around said substrate.

5. A chairmat as recited in claim 1 wherein said decorative material comprises at least one selected from paint, pencil, plastic, ink, paper, charcoal, crayon and glue.

6. A chairmat as recited in claim 1 wherein said substrate comprises a non-electrically conductive material.

7. A chairmat as recited in claim 1 wherein said substrate layer is formed of a non-electrically conductive material.

8. A chairmat as recited in claim 1 wherein said decorative material is disposed on a lower surface of said substrate.

9. A chairmat as recited in claim 1 wherein said decorative material is disposed on an upper surface of said substrate.

10. A chairmat as recited in claim 1 wherein said substrate layer is formed of a polymer.

11. A chairmat as recited in claim 1 wherein the seal layer and decorative material are integral.

12. A chairmat for a floor comprising:
a U substrate layer having a first side adjacent to the floor and a second side opposite the floor;
a first decorative material directly disposed on a first area of said second side of said substrate layer;
a second decorative material directly disposed on a second area of said second side of said substrate layer; and
a transparent seal layer directly disposed on said first decorative material and said second decorative material opposite said substrate layer.

13. A chairmat as recited in claim 12 wherein said first area and said second area are distinct.

14. A chairmat as recited in claim 12 wherein said first area and said second area are at least partially over-lapping.

15. A chairmat as recited in claim 12 wherein said first decorative material is integral with said seal layer.

16. A chairmat as recited in claim 12 wherein said second decorative material is integral with said seal layer.
